(19) United States
(12) Patent Application Publication
(10) Pub. No.: US 2015/0161049 A1
(43) Pub. Date: Jun. 11, 2015

(54) SYSTEM AND METHOD FOR STATE-DRIVEN DYNAMIC CACHE MEMORY CONFIGURATION FOR MODEMS IN A PORTABLE COMPUTING DEVICE

(71) Applicant: Qualcomm Incorporated, San Diego, CA (US)

(72) Inventor: STEVEN D. CHENG, SAN DIEGO, CA (US)

(73) Assignee: Qualcomm Incorporated, San Diego, CA (US)

(21) Appl. No.: 14/102,412

(22) Filed: Dec. 10, 2013

(51) Int. Cl. G06F 12/08

(52) U.S. Cl. CPC G06F 12/0831

(57) ABSTRACT

Systems and methods that enable state-driven dynamic cache memory configuration for modems such as those used in or with a portable computing device (PCD) are presented. During operation of the PCD an indication of a modem state of the PCD is received. Based on the modem state a new cache configuration is determined. The new cache configuration is applied to a modem cache memory, providing a cost effective ability to dynamically configure the modem cache in order to improve connectivity, reduce resource conflict, reduce power consumption, reduce latency, improve battery life, maximize thermal performance, and/or improve QoS as desired.

### DESCRIPTION OF THE RELATED ART

Devices with a processor that communicate with other devices through wireless signals, including portable computing devices (PCDs), are ubiquitous. These devices may include cellular telephones, portable digital assistants (PDAs), portable game consoles, palmtop computers, and other portable electronic devices. In addition to the primary function of these devices, many include peripheral functions. For example, a cellular telephone may include the primary function of enabling and supporting cellular telephone calls and the peripheral functions of a still camera, a video camera, global positioning system (GPS) navigation, web browsing, sending and receiving emails, sending and receiving text messages, push-to-talk capabilities, etc. Additionally, it is becoming common for such devices to not only support cellular telephone calls, but to support communications, including calls and/or data transfers over an ever-increasing number of wireless communication systems.

As the functionality of such a device increases, the computing or processing power and/or memory required to support such functionality at desired service levels also increases. Additionally, it is well established that power storage capacity is a limiting factor, as is shortened battery life for such devices caused by the ever-increasing loads. Accordingly, attempts to minimize power consumption, improve performance, and/or improve quality of service (“QoS”) in PCDs welcome.

PCDs also routinely include a modem or modem functionality to control, for example, the communications of the PCD over wireless networks. Such modems may include a separate processor, or may be controlled by a general processor controlling one or more other functionalities of the PCD. Such modem functionality, including the memory that the model will be allowed to access, is typically pre-set or pre-programmed by the manufacturer, and often implementing the modem in differing PCD architectures requires pre-programming or pre-setting the modem differently during the manufacturing process depending on which PCD the modem will be used.

Additionally, the power, memory, and resource needs of modems can vary greatly depending on the operating state of the PCD. For example, the resource needs of the modem when the PCD is in an idle state may be very different from the needs of the modem when the modem is attempting to transfer connectivity of the PCD between two different wireless communication systems.

Thus, there is a need for improved mechanisms for optimizing the modem functionality in a PCD, and allowing for more easily deployed modem functionality across a variety of PCD architectures.

### SUMMARY OF THE DISCLOSURE

Systems and methods are disclosed that enable state-driven dynamic cache memory configuration for modems such as those used in or with a portable computing device (“PCD”). During operation of the PCD an indication of a modem state of the PCD is received. Based on the modem state a new cache configuration is determined. The new cache configuration is applied to a modem cache memory, providing a cost effective ability to dynamically configure the modem cache in order to improve connectivity, reduce resource conflict, reduce power consumption, reduce latency, improve battery life, maximize thermal performance, and/or improve QoS as desired.

One example embodiment is a PCD including a modem device, where the modem device includes a processing resource configured to receive an indication of a modem state during operation of the PCD. The processing resource is also configured to determine a new cache configuration from the modem state, and apply the new cache configuration to a modem cache memory.

Another example embodiment is a method for state-driven dynamic modem cache configuration in a PCD. The method may include the steps of receiving during operation of the PCD an indication of a modem state, determining a new cache configuration from the modem state; and applying the new cache configuration to a modem cache memory.

Yet another example embodiment is a non-transitory processor-readable medium having stored thereon processor instructions that direct the processor to perform functions for state-driven dynamic modem cache configuration in a portable computing device (PCD), comprising: receiving during operation of the PCD an indication of a modem state; determining a new cache configuration from the modem state; and applying the new cache configuration to a modem cache memory.

### BRIEF DESCRIPTION OF THE DRAWINGS

In the drawings, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1 is a diagram showing a portable computing device (PCD) communicating with a wireless communication system.

FIG. 2A is a schematic diagram illustrating an example embodiment of a PCD.

FIG. 2B is schematic diagram illustrating an example aspect of the PCD illustrated in FIG. 2A.

FIG. 3 is a block diagram of a second example aspect of the PCD illustrated in FIG. 2.

FIG. 4 is a block diagram showing an example modem device aspect of the PCD illustrated in FIG. 3.

FIG. 5 is a block diagram showing an example configuration of hardware for an aspect of the modem device illustrated in FIG. 4.

FIG. 6 is an exemplary state diagram showing one embodiment of exemplary states for the modem device illustrated in FIG. 4.

FIG. 7A is a flowchart describing an exemplary embodiment of a method for state-driven dynamic cache memory configuration in modems used in or with a PCD.

FIG. 7B illustrates example components capable of performing the method illustrated in FIG. 7A.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files or data values that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer-readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the term “portable computing device” (“PCD”) is used to describe any device operating on a limited capacity rechargeable power source, such as a battery and/or capacitor. Although PCDs with rechargeable power sources have been in use for decades, technological advances in rechargeable batteries coupled with the advent of third generation (“3G”) and fourth generation (“4G”) wireless technology have enabled numerous PCDs with multiple capabilities. Therefore, a PCD may be a cellular telephone, a satellite telephone, a pager, a PDA, a smartphone, a navigation device, a smartbook or reader, a media player, a combination of the aforementioned devices, a laptop or tablet computer with a wireless connection, among others.

The present systems and methods for enabling state-driven dynamic cache memory configuration for modems such as those used in or with a portable computing device (PCD) provide a cost effective ability to dynamically configure the modem cache in order to improve connectivity, reduce resource conflict, reduce power consumption, reduce latency, improve battery life, maximize thermal performance, and/or improve QoS as desired.

During operation of the PCD an indication of a modem state of the PCD is received. Based on the modem state a new cache configuration is determined. The new cache configuration is applied to a modem cache memory. The present solution allows for cache configurations at each modem state tailored to the PCD architecture as well as desired performance objections, including objectives of the PCD manufacturer in which the modem will be implemented. Thus, the present systems and methods provide a scalable approach that may be deployed across a wide variety of PCD architectures and/or modem architectures.

In an example embodiment, a PCD includes a modem device. The modem of the PCD includes a processing resource configured to receive an indication of a modem state during operation of the PCD. The processing resource is also configured to determine a new cache configuration from the modem state, and apply the new cache configuration to one or more modem cache memories.

In an example embodiment, the modem states may be states defined by a particular wireless communications protocol or technology on which the PCD is “camped.” Additionally, the modem states may also be defined by the PCD or modem device, or may be defined by a combination of the wireless communications protocol/technology and the PCD. In some implementations the different modem states may place varying requirements on the modem, as well as other components of the PCD. A feature of an exemplary embodiment is the ability to dynamically configure the cache that the modem accesses to address, among other concerns, the differing requirements of the various modem states.

Such modem cache configurations are based at least in part on the state of the modem and may in some embodiments include: setting or limiting which and/or how many cache memories (including an L1 cache, L2 cache, external memory) will be used or accessed by the modem; setting how fast one or more of the cache memories will operate and/or how fast one or more of the cache memories will be populated; limiting the information or types of information that may be placed into one or more of the cache memories; and/or setting or limiting the availability of other features related to the cache memories, such as enabling or disabling pre-fetching for one or more of the cache memories.

Additionally, in some example embodiments other factors or parameters may be taken into consideration when determining and applying the new cache configurations. For instance, physical PCD parameters such as the architecture of the PCD, including the architecture of the modem device may be taken into consideration. Examples of a physical PCD parameter include the number of physical cache available to the modem device, the size of the cache available to the modem device, whether the available cache is shared with other processors of the PCD performing other functions, and/or whether the processor of the modem device performs other functions for the PCD. Other parameters may also be taken into consideration in example embodiments. Such additional parameters could include operational PCD parameters such as a battery level, an average power consumption, and/or a thermal condition/threshold of the PCD.

Although described with particular reference to operation within a PCD, the described state-driven dynamic cache memory configuration for modems systems and methods are applicable to any larger system with a processor, or processing subsystem, and a state or mode driven modem where it is desirable to conserve power consumption, enhance performance, or improve quality of service. Stated another way, the state-driven modem dynamic cache memory configuration may be provided to dynamically configure modem cache memory in a system other than in a portable device.

The modem device and processor resource, and their respective components, are hardware devices that can include any or a combination of the following technologies, which are all well known in the art: discrete electronic components, an integrated circuit, an application-specific integrated circuit having appropriately configured semiconductor devices and resistive elements, etc. Any of these hardware devices, whether acting or alone, with other devices, or other components such as a memory may also form or comprise means for performing various operations or steps of the disclosed methods.

When a PCD or other system is implemented partially in software, the software portion can be used to receive an indication of a modem state during operation of the PCD, determine a new cache configuration from the modem state, and apply the new cache configuration to one or more modem cache memories. The software and data used in representing various elements can be stored in a memory and executed by a suitable instruction execution system (microprocessor). The software may comprise an ordered listing of executable instructions for implementing logical functions, and can be embodied in any “processor-readable medium” for use by or in connection with an instruction execution system, apparatus, or device, such as a single or multiple-core processor or processor-containing system. Such systems will generally access the instructions from the instruction execution system, apparatus, or device and execute the instructions.

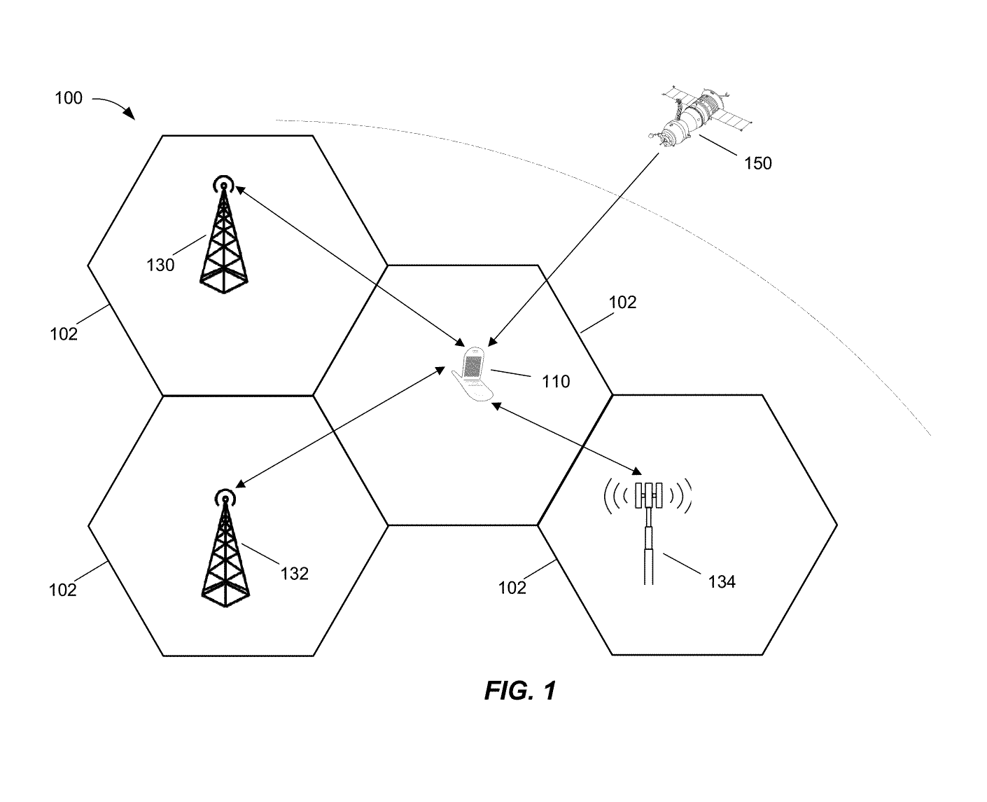

FIG. 1 is a diagram showing a wireless device 110 communicating with a wireless communication system 100 in which embodiments of the present disclosure may be employed. The wireless communication system 100 may be broadband wireless communication system, including a Long Term Evolution (LTE) system, a Code Division Multiple Access (CDMA) system, a Frequency Division Multiple Access (FDMA) system, a Global System for Mobile Communications (GSM) system, a wireless local area network (WLAN) system, some other wireless system, or a combination of any of these. A CDMA system may implement Wideband CDMA (WCDMA), CDMA 1X, Evolution-Data Optimized (EVDO), Time Division Synchronous CDMA (TD-SCDMA), or some other version of CDMA. Each or any of the above systems may be generically referred to herein with the label “wireless communications protocol” or a “wireless communications technology.”

The wireless communication system 100 may provide communication for a number of cells 102, each of which may be serviced by a base station 130 and 132 or other communication network component. The base stations 130 and 132 may alternatively be referred to as access points, Node Bs, or some other terminology. For simplicity, FIG. 1 shows wireless communication system 100 including two base stations 130 and 132. In general, a wireless communication 100 system may include any number of base stations 130, 132 and any set of network entities.

FIG. 1 depicts a single PCD/wireless device 110 connected to the system. The wireless device 110 may also be referred to as a user equipment (UE), a mobile station, a terminal, an access terminal, a subscriber unit, a station, etc. Wireless device 110 may be a cellular phone, a smartphone, a tablet, a wireless modem, a personal digital assistant (PDA), a handheld device, a laptop computer, a smartbook, a netbook, a tablet, a cordless phone, a wireless local loop (WLL) station, a Bluetooth device, etc. Although only one wireless device 110 is illustrated in FIG. 1 for simplicity's sake, there may be multiple wireless devices connected to the communication system 100, including multiple wireless devices 100 connected to each base station 130 and 132. Moreover, wireless devices 110 may be fixed (i.e. stationary) or mobile, such as a wireless device 110 located in or affixed to a vehicle.

Wireless device(s) 110 may communicate with wireless communication system 100 using a variety of algorithms and methods. Wireless device 110 may also receive signals from broadcast stations (e.g., a broadcast station 134), signals from satellites (e.g., a satellite 150) in one or more global navigation satellite systems (GNSS), etc. Wireless device 110 may support one or more wireless communications technologies for wireless communication such as LTE, WCDMA, CDMA 1x, FDMA, EVDO, TD-SCDMA, GSM, 802.11, etc. A communication link that facilitates transmission from a base station 130, 132 to a wireless device 110 may be referred to as a down link, and a communication link that facilitates transmission from a wireless device 110 to a base station 130, 132 may be referred to as an uplink.

Additionally, the wireless communication network 100 may provide communications for a number of cells 102, each of which is serviced by a base station 130, 132. A cell 102 may be further divided into multiple sectors (not shown), comprising physical coverage areas within a cell 102. Base stations 130, 132 may utilize antennas that concentrate the flow of power within a particular sector of a cell 102.

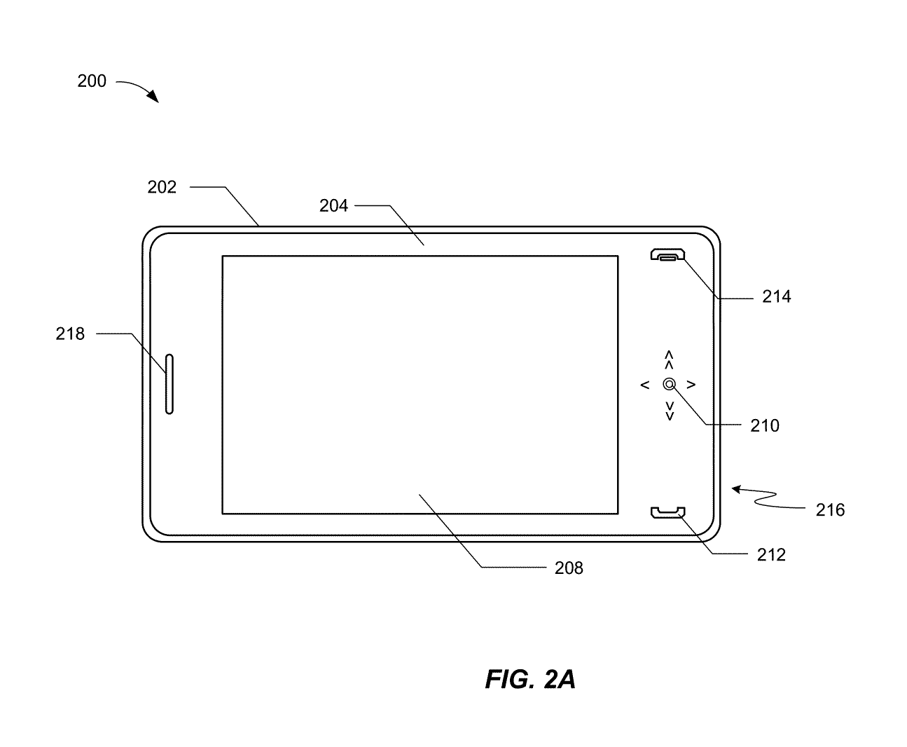

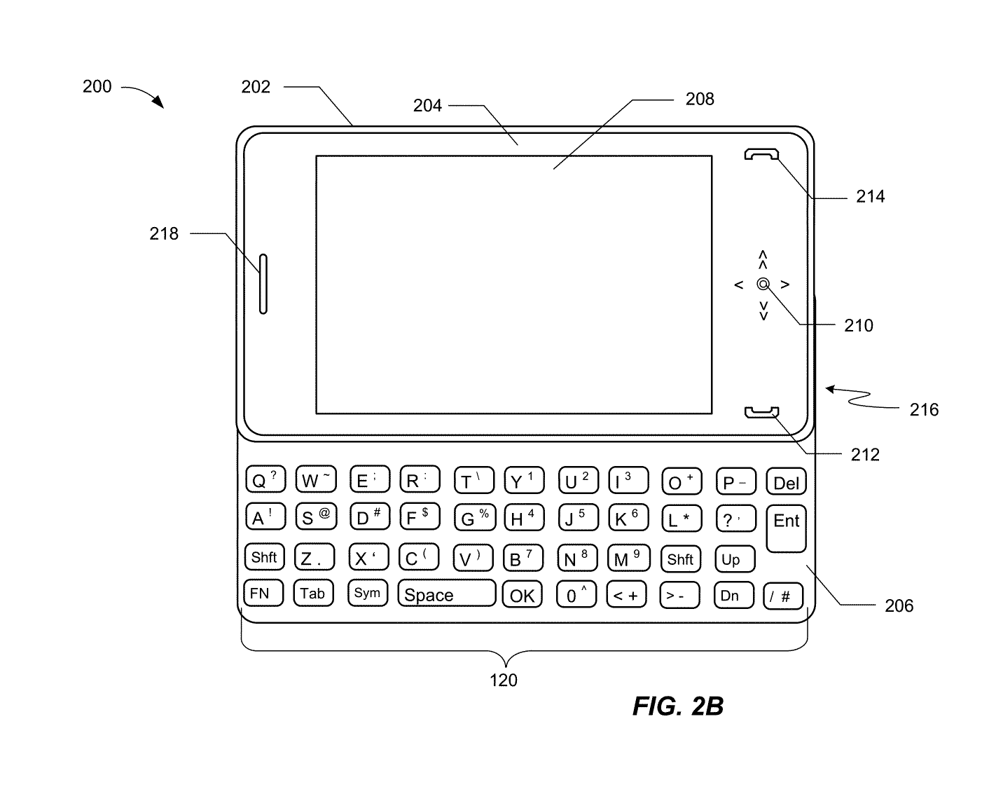

Referring to FIG. 2A and FIG. 2B, an exemplary portable computing device (PCD) 200 that may be a wireless device 110 used within the wireless communication network 100 described in FIG. 1 is shown. The PCD 200 includes a housing 202. The housing 202 has an upper housing portion 204 and a lower housing portion 206. FIG. 2A shows that the upper housing portion 204 may include a display 208. In a particular aspect, the display 208 may be a touch screen display. The upper housing portion 204 may include a trackball input device 210. Further, as shown in FIG. 2A, the upper housing portion 204 includes a power on button 212 and a power off button 214, a speaker 218 and a microphone 216. In an alternative embodiment (not shown) a single pushbutton may be arranged to enable a power on mode and thereafter a power off mode. Additional pushbutton(s) may be provided to control operation of various subsystems arranged within the housing 202. For example, the PCD 200 may be arranged with a pushbutton (not shown) to answer a phone call communicated to the PCD by a cellular service provider.

In a particular aspect, as depicted in FIG. 2B, the upper housing portion 204 is movable relative to the lower housing portion 206. Specifically, the upper housing portion 204 may be slidable relative to the lower housing portion 206. As shown in FIG. 2B, the lower housing portion 206 includes a multi-button keyboard 220. In a particular aspect, the multi-button keyboard 220 may be a standard QWERTY keyboard. The multi-button keyboard 220 may be revealed when the upper housing portion 204 is moved relative to the lower housing portion 206.

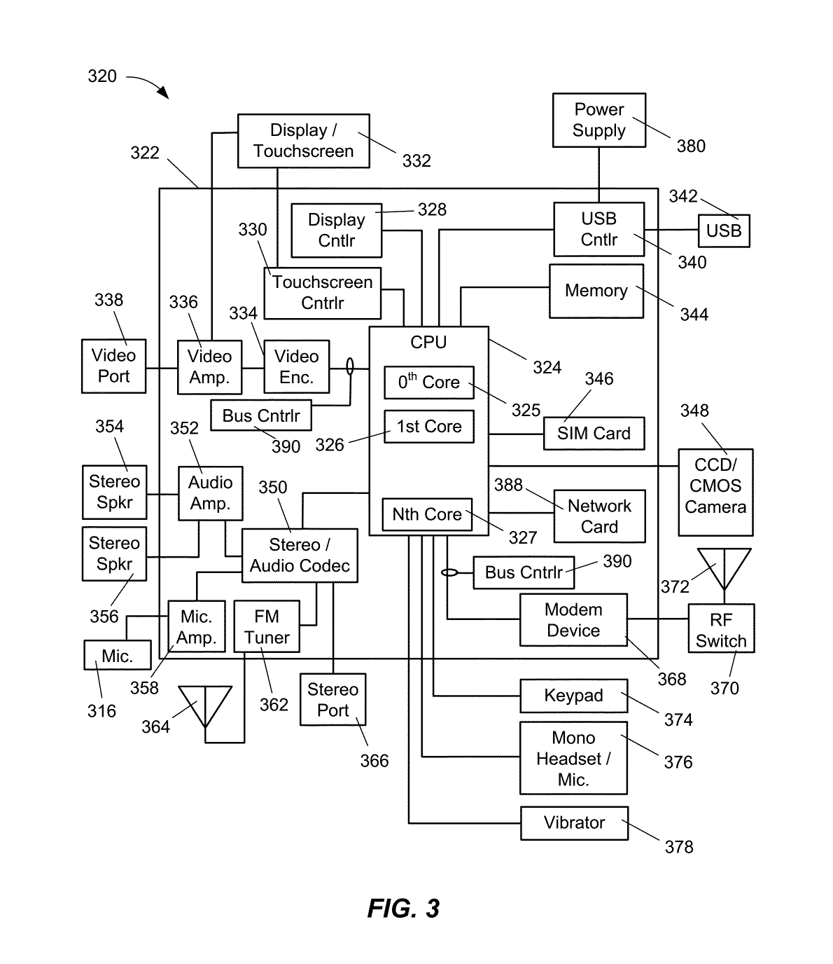

Referring to FIG. 3, a block diagram of an exemplary, non-limiting aspect of a portable computing device (PCD) is shown and is generally designated 320. As shown, the PCD 320 includes an on-chip system 322 that includes a multicore CPU 324. The multicore CPU 324 includes a zeroth core 325, a 1^{st} or first core 326, and an N^{th} core 327.

As illustrated in FIG. 3, a display controller 328 and a touch screen controller 330 are coupled to the multicore CPU 324. In turn, display/touchscreen 332, external to the on-chip system 322, is coupled to the display controller 328 and the touch screen controller 330.

FIG. 3 further indicates that a video encoder 334, e.g., a phase alternating line (PAL) encoder, a sequential couleur a memoire (SECAM) encoder, or a national television system(s) committee (NTSC) encoder, is coupled to the multicore CPU 324. Further, a video amplifier 336 is coupled to the video encoder 334 and the display/touchscreen 332. Also, a video port 338 is coupled to the video amplifier 336. As depicted in FIG. 3, a universal serial bus (USB) controller 340 is coupled to the multicore CPU 324. Also, a USB port 342 is coupled to the USB controller 340. A memory 344 and a subscriber identity module (SIM) card 346 may also be coupled to the multicore CPU 324. In other embodiments, multiple SIM cards 346 may be implemented. In such embodiments, each of the multiple SIM cards 346 may be configured for communications over the wireless communications network 100 (see FIG. 1) using a different wireless communications protocol. In some embodiments the one or more SIM cards 346 may also be in communication with the modem device 368 described more fully below.

Further, as shown in FIG. 3, a digital camera 348 may be coupled to the multicore CPU 324. In an exemplary aspect, the digital camera 348 is a charge-coupled device (CCD) camera or a complementary metal-oxide semiconductor (CMOS) camera. As further illustrated in FIG. 3, a stereo audio CODEC 350 may be coupled to the multicore CPU 324. Moreover, an audio amplifier 352 may be coupled to the stereo audio CODEC 350. In an exemplary aspect, a first stereo speaker 354 and a second stereo speaker 356 are coupled to the audio amplifier 352.

FIG. 3 shows that a microphone amplifier 358 may be also coupled to the stereo audio CODEC 350. Additionally, a microphone 316 may be coupled to the microphone amplifier 358. In a particular aspect, a frequency modulation (FM) radio tuner 362 may be coupled to the stereo audio CODEC 350. Also, a FM antenna 364 is coupled to the FM radio tuner 362. Further, a stereo port 366 may be coupled to the stereo audio CODEC 350.

FIG. 3 further indicates that a modem device 368 may be coupled to the multicore CPU 324. The modem device 368 may support one or more of the wireless communications protocols, such as GSM, CDMA, W-CDMA, TDSCDMA, LTE, and variations of LTE such as, but not limited to, FDB/LTE and PDD/LTE wireless protocols. Additionally, there may be multiple modem devices 368, and in such embodiments, different modem devices 368 may support come or all of the wireless communication protocols and/or technologies listed above.

The modem device 368 may be further comprised of various components, including a separate processor, memory, and/or a radio frequency (RF) transceiver. Further, the modem device 368 may be incorporated in an integrated circuit. That is, the components comprising the modem device 368 may be a full solution in a chip. Additionally, various components comprising the modem device 368 may also be coupled to the multicore CPU 324. An RF switch 370 may be coupled to the modem device 368 and an RF antenna 372. In various embodiments, there may be multiple RF antennas 372, and each such RF antenna 372 may be coupled to the modem device through an RF switch 370.

As shown in FIG. 3, a keypad 374 is coupled to the multicore CPU 324. Also, a mono headset with a microphone 376 may be coupled to the multicore CPU 324. Further, a vibrator device 378 may be coupled to the multicore CPU 324. FIG. 3 also shows that a power supply 380 may be coupled to the on-chip system 322 via the USB controller 340. In a particular aspect, the power supply 380 is a direct current (DC) power supply that provides power to the various components of the PCD 320 that require power. Further, in a particular aspect, the power supply is a rechargeable DC battery or a DC power supply that is derived from an alternating current (AC) to DC transformer that is connected to an AC power source.

FIG. 3 further indicates that the PCD 320 may also include a network card 388 that may be used to access a data network, e.g., a local area network, a personal area network, or any other network. The network card 388 may be a Bluetooth network card, a WiFi network card, a personal area network (PAN) card, or any other network card well known in the art. Further, the network card 388 may be incorporated in an integrated circuit. That is, the network card 388 may be a full solution in a chip, and may not be a separate network card 388.

As depicted in FIG. 3, the display/touchscreen 332, the video port 338, the USB port 342, the camera 348, the first stereo speaker 354, the second stereo speaker 356, the microphone 316, the FM antenna 364, the stereo port 366, the RF switch 370, the RF antenna 372, the keypad 374, the mono headset 376, the vibrator 378, and the power supply 380 are external to the on-chip system 322.

As further indicated in FIG. 3, two instances of a bus controller 390 are provided. The bus controller 390 is responsive to signals in the bus interface that communicatively couples the CPU 324 to components of a wireless subsystem, e.g., the modem device 368, RF switch 370 and antenna 372. A second instance of a bus controller 390 is responsive to signals in the bus interface that communicatively couple the CPU 324 to components of a multimedia subsystem.

In the illustrated embodiment, two instances of a bus controller 390 are depicted. However, it should be understood that any number of similarly configured bus controllers 390 can be arranged to monitor a bus interface arranged in the on-chip system 322. Alternatively, a single bus controller could be configured with inputs arranged to monitor two or more bus interfaces that communicate signals between CPU 324 and various subsystems of the PCD 320 as may be desired.

In a particular aspect, one or more of the method steps described herein may be enabled via a combination of data and processor instructions stored in the memory 344. These instructions may be executed by the multicore CPU 324 in order to perform the methods described herein. Further, the multicore CPU 324, the memory 344, the modem device 368, components of the modem device 368, or a combination thereof may serve as a means for executing one or more of the method steps described herein in order enable state-driven dynamic cache memory configuration.

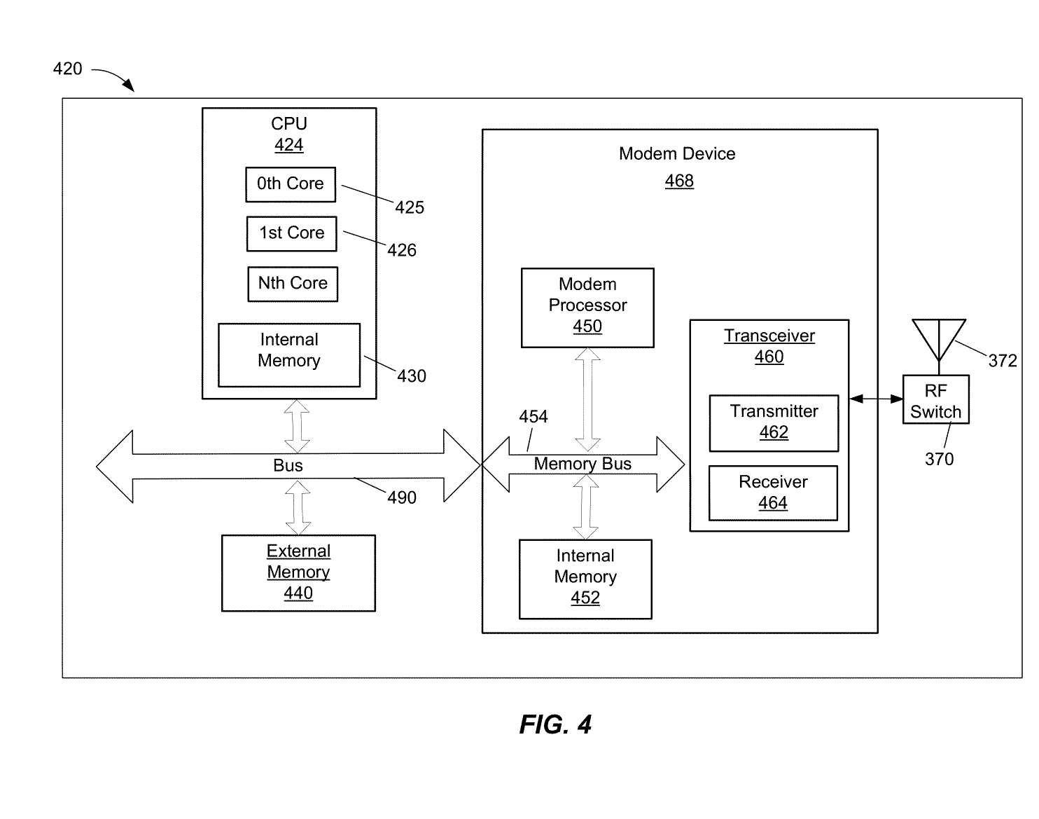

FIG. 4 is an illustration of an embodiment of an aspect of the PCD 320 illustrated in FIG. 3. In the illustrated embodiment, the PCD 420 may include a multicore PCU 424, an external memory 440, and a modem device 468, each of which may be coupled to a common data bus 490. The multicore CPU 424 may include a zeroth core 425, a 1st or first core 426, an Nth core 427 and an internal memory or cache 430.

The modem device 468 may include a modem processor 450 and an internal memory device 452 (such as a cache) coupled to a memory bus 454, which memory bus 454 may also enable interconnectivity with the data bus 490. In order to avoid confusion between the memory device 440 and the internal memory device 430 or the multicore CPU 424 and the internal memory device 452 of the modem device 468, the memory device 440 may be referred to herein as an external memory device 440. The modem device 468 also includes a transceiver 460, which further includes transmitter 462 and receiver 464 modules. The transceiver 460 is also coupled to the memory bus 454 and to an antenna 472 through an RF switch 470.

In other embodiments, the modem device 468 could include additional components and/or more of the components shown in FIG. 2, such as an additional modem processor 450, additional transceiver 460, or an additional one or more antenna 472. Further, in some embodiments, there may be multiple such modem devices 468 as discussed above with respect to FIG. 3. In embodiments with multiple modem devices 468, each modem device 468 could be configured as illustrated in FIG. 4, or one or more of the modem devices 468 could have different configurations/components than illustrated in FIG. 4.

The multicore CPU 424, modem processor 450 and/or transceiver 460 may form a transmit chain and/or a receive chain that operates to process, transmit and/or receive one or more concurrent or serial data streams to and/or from the PCD 420. In one example, each data stream may be transmitted/received over a respective transmit/receive antenna 472. For data to be transmitted, the modem processor 450 may modulate the data by formatting, coding, and/or interleaving the traffic data for each data stream based on a particular coding scheme selected for that data stream to provide coded data.

Similarly, for received data, the modem processor 450 may demodulate the data by de-interleaving, decoding, and/or extracting the traffic data for each data stream based on the particular coding scheme being used. At the transceiver 460, the transmitter module 462 may processes a data stream to provide one or more analog signals and may further condition (e.g., amplify, filter, and/or up convert) the analog signals to provide a modulated signal suitable for transmission over one or more antennas 472. Similarly, the receiver module 464 may receive modulated signals from one or more antennas 472 and may condition (e.g., filter, amplify, and/or downconvert) a received signal, digitize the conditioned signal to provide samples, and further process the samples to provide a corresponding received data stream.

In various implementations the modem processor 450 may reside on the multicore CPU 424, on the same circuit board of the PCD 420 as the multicore CPU 424, or on a separate circuit board of the PCD 420 from the multicore CPU 424. For instance, the modem processor 450 may be part of an independent or removable communication card that plugs into the PCD 420, or as a separate hardware component that plugs into a PCD 420 or other system with a processor. Moreover, modem processor 450 may be implemented as a single processor or multiple processors in different embodiments.

Additionally, in various implementations, the internal memory 430 of the multicore CPU 424 may be one or more cache memories, such as an L1 CPU cache and/or L2CPU cache. Similarly, the internal memory 452 of the modem device may be one or more cache memories, such as an L1 modem cache and/or L2 modem cache. In some implementations, one or more of the L1 CPU cache, L2 CPU cache, L1 modem cache, and L2 modem cache may be shared cache, such that they may be accessed by one or more of the cores 425, 426, 427 of the multicore CPU 424 and/or by the modem processor 450. In some implementations, one or more of the L1 CPU cache, L2 CPU cache, L1 modem cache, and L2 modem cache may be located on the same circuit board, or may be located on a combination of different circuit boards. For example, in some implementation, the L1 CPU cache, L2 CPU cache, L1 modem cache, and L2 modem cache may all be located on the same circuit board of the PCD 420 as the multicore CPU 424. While, in other implementations the L1 CPU cache and L2 CPU cache may be on a separate circuit board of the PCD 420 from one or more of the L1 modem cache or L2 modem cache. In some implementations, the external memory 440 may be multiple memories, such as multiple caches, including a DDR external cache that may be accessed by one or more of the cores 425, 426, 427 of the multicore CPU 424 and the modem processor 450.

According to one feature of the PCD 420, the modem processor 450 may be adapted to enable state-driven dynamic cache memory configuration. For example, the modem processor 450 may be adapted to execute programming or executable code causing the modem processor receive a modem state, to determine a change of the modem state, to determine whether new cache configurations are needed, and to configure the cache memory. By way of example and not limitation, the configuration of the cache memory changed may include the amount of a cache memory to be used in the new modem state, the number different cache memories to be used in the new modem state, how quickly various caches will operate and/or populate, and whether functionality such as pre-fetching will be enabled for all or some of the cache memory or a combination thereof. Such programming or executable code may be stored in a processor readable medium (e.g., in external memory device 440 or internal memory device 452).

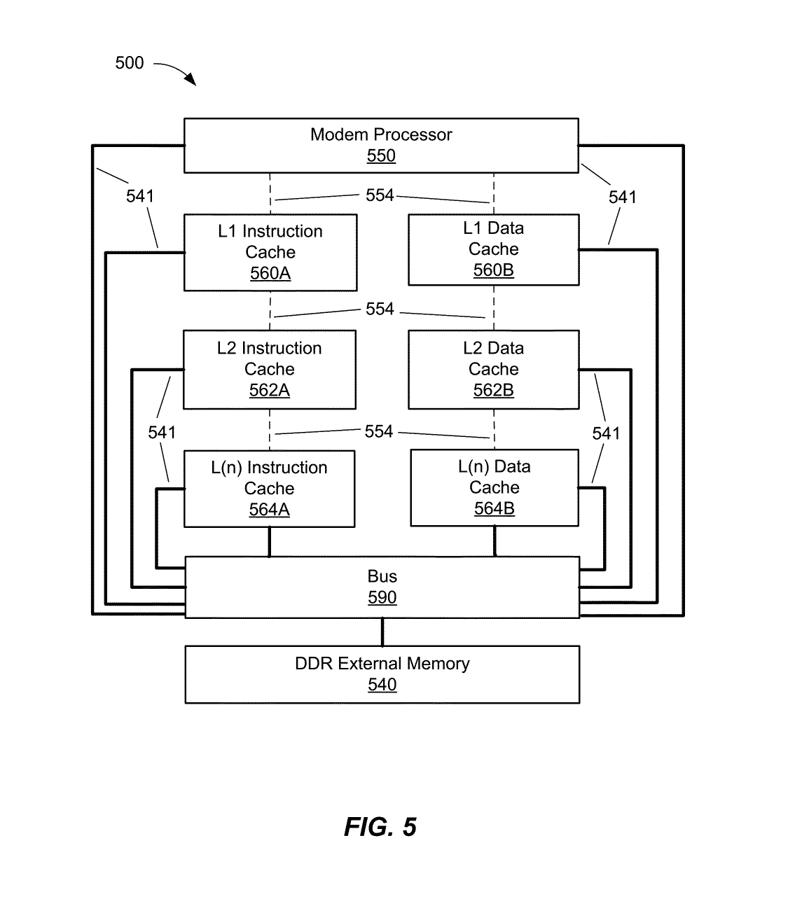

FIG. 5 is a block diagram illustrating an example configuration of certain modem hardware 500 for an aspect of the modem device 468 of FIG. 4. Such a modem device 468 may be dedicated to one or more wireless communications protocols, including, for example, 2G, 3G, 4G, and/or WiMAX. The modem hardware 500 may consist of one or more processor, memory, buses, and other hardware components. The processors may be further divided into a general purpose computing modem processor 550 as well as additional processors. Although only a single modem processor 550 is shown in FIG. 5 for simplicity's sake, it is to be understood that the illustrated modem processor 550 could include additional processors, whether general or dedicated, as part of or acting with the modem processor 550.

The memory may include L1 cache, which may be further divided into L1 instruction cache 560A and L1 data cache 560B. The memory may also include L2 cache, which may be further divided into L2 instruction cache 562A and L2 data cache 562B. The memory may include a further number L(n) of cache(s), which each may be further divided into L(n) instruction cache(s) 564A and L(n) data cache(s) 564B. The memory may also include in additional internal memory (not shown) as well as one or more external memories, such as DDR external memory 540.

The various cache memories discussed above may be in communication with the modem processor 550 and any additional local processors via local bus connections 554. Similarly, the caches discussed above, the external memory (such as DDR external memory 540) and the modem processor 550 may be in contact the bus 590 vial external bus connections 541. Further, one or more of the hardware components 500 may have an independent clock. Thus, processors, memory, and buses may be running at the same or at different speeds in various implementations.

Additionally, although described as a modem processor 550, it will be understood that depending on the implantation, the modem processor 550 may perform processing functions for or in support of other features of the PCD 320/420. For example, in some implementations what is labeled the modem processor 550 may also be the processor that supports or handles processing for the GPS functions of the PCD 320/420. In other implementations, the modem processor 550 may support or handle other processing duties instead of, or in addition to GPS functionality.

Similarly, it will be understood that the L1 cache, L2 cache, L(n) cache, and/or external memory may also be shared and/or used to support additional functionality of the PCD 320/420 in additional to the modem device 368/468. For instance, continuing the example above where in an implementation the modem processor 550 is also the processor that supports or handles processing for the GPS functions, the L1 cache, L2 cache, L(n) cache, and/or external memory accessed by the modem processor 550 may also be used in support of the GPS functions. For another example, in other implementations, the L1 cache, L2 cache, L(n) cache, and/or external memory may also be accessed by other processors performing or handling other functions of the PCD, such as audio processing.

According to one feature of an exemplary embodiment, the modem processor 550 acting alone or in conjunction with other components or portions of the PCD 320/420 may operate to dynamically configure one or more of L1 instruction cache 560A, L1 data cache 560B, L2 instruction cache 562A, L2 data cache 562B, L(n) instruction cache 564A, L(n) data cache 564B, or DDR external memory 540.

Depending on the state of the modem device, such configurations may include for example, setting or limiting which and/or how many of the L1 cache, L2 cache, L(n) cache, or DDR external memory will be used or accessed by the modem device 368/468 in the modem state. In other implementations, such configurations could include setting only portions of one or more of the above cache or memory to be used or accessed by the modem device 368/468. By way of a non-limiting example, in such implementations, the configurations could include the modem processor 550 limiting the available cache for the modem device 368/468 in a particular modem state to be only a portion of L1 instruction cache 560A and a portion of L1 data cache 560B. Continuing this example, in some implementations the portions of L1 instruction cache 560A and L1 date cache 560B may be roughly equal in size, while in other implementations, the portion of L1 instruction cache 560A may be larger than the portion of the L1 data cache 560B (or vice versa).

By way of another non-limiting example, the configurations could include the modem processor 550 setting the available cache for the modem device 368/468 in a particular modem state to be all of L1 instruction cache 560A, all of L1 data cache 560B, all of L2 instruction cache 562A, all of L2 data cache 562B, and a portion of DDR external memory. As will be understood, any such combination of portions or all of any of the available caches or memories may be set as available to (or unavailable to) the modem device 368/468 as part of the configurations.

In addition to setting the number and amounts of cache available for a particular modem state, other features may also be set as part of the configurations. For instance, the modem processor 550 may also configure or set how fast one or more of the caches are operating and/or how fast one or more of the cache is being populated. Such configurations may be made by the modem processor 550 in implementations, for example, when one or more of the L1 cache, L2 cache, L(n) cache, of bus 590 have an independent clock and/or in implementations when the L1 cache, L2 cache, L(n) cache, of bus 590 do not have an independent clock. As will be understood, other such configurations of different caches (depending on the kind, location, and/or architecture of the cache(s) for example) are possible in order to set or limit how fast one or more of the caches are operating and/or being populated.

Similarly, as part of the configurations, the modem processor 550 may limit the information or types of information that may be placed into one or more of the caches or memories. For example, the modem processor 550 may, depending on the state of the modem device 368/468, limit the information about base stations 130/132 being loaded into one or more of the caches to information about 2G base stations, but not information about 3G or 4G base stations. Such implementations could further include limiting the instructions to be loaded into one or more instruction caches to instructions concerning about 2G base stations, limiting the data to be loaded into one or more data caches to data concerning 2G base stations, or both.

For another example, in some implementations the PCD 320/420 may include multiple antennas 372/472 but only one of the antennas 372/472 is used in a certain state of the modem device 368/468. For such implementations, the modem processor 550 may for that state of the modem device 368/468 limit the information about antennas 372/472 to be loaded into cache to the information about the single antenna 372/472 being used in the state. As will be understood, depending on the implementation, other such limitations or configurations of the information or types of information may by the modem processor 550 are similarly possible.

Further, as part of the configurations, the modem processor 550 may also set or configure other functions related to the caches and/or external memory. For example, in some implementations, depending on the state of modem device 368/468, the modem processor 550 may enable or disable pre-fetching functionality for one or more of the caches and/or external memory as part of the configurations. Continuing this example, in some implementations pre-fetch may be enabled only for L1 cache in one state of the modem device 368/468, pre-fetch may be enabled for all caches for a second state of the modem device 368/468, pre-fetch may be disabled for all caches and external memory for a third state of the modem device 368/468 and/or pre-fetching may be enabled for only a portion of L2 cache in a fourth state of the modem device 368/468. In each of the above examples, enabling pre-fetch as part of the configurations for one or more cache or memory could further include selecting the pre-fetch methodology and/or algorithm being implemented. As will be understood, depending on the implementation configuring other such functions related to the caches and/or external memory by the modem processor 550 is possible.

The above examples of configurations are not mutually exclusive. Any part of any of the above configurations may be implemented by the modem processor 550, acting alone or with other components of the PCD 320/420, based on the state of the modem device 368/468. For example, in some implementations, depending on the state, the memory processor 550 may disable L2 and L(n) cache, but enable L1 cache and enable pre-fetch for L1 cache. Similarly, in some implementations, depending on the state, all of the caches and available external memories may be enabled while pre-fetch is disabled for all of the caches and external memories. While, in in yet other implementations, depending on the state L1 cache may be enable, pre-fetch disabled for the L1 cache, and the modem processor 550 may limit the instructions loaded into the L1 cache to instructions related to 2G base stations. These are merely illustrations of some of the possibilities, and are not intended as a full recitation of the possible combination of configurations that may be implemented by modem processor 550 in an exemplary embodiment.

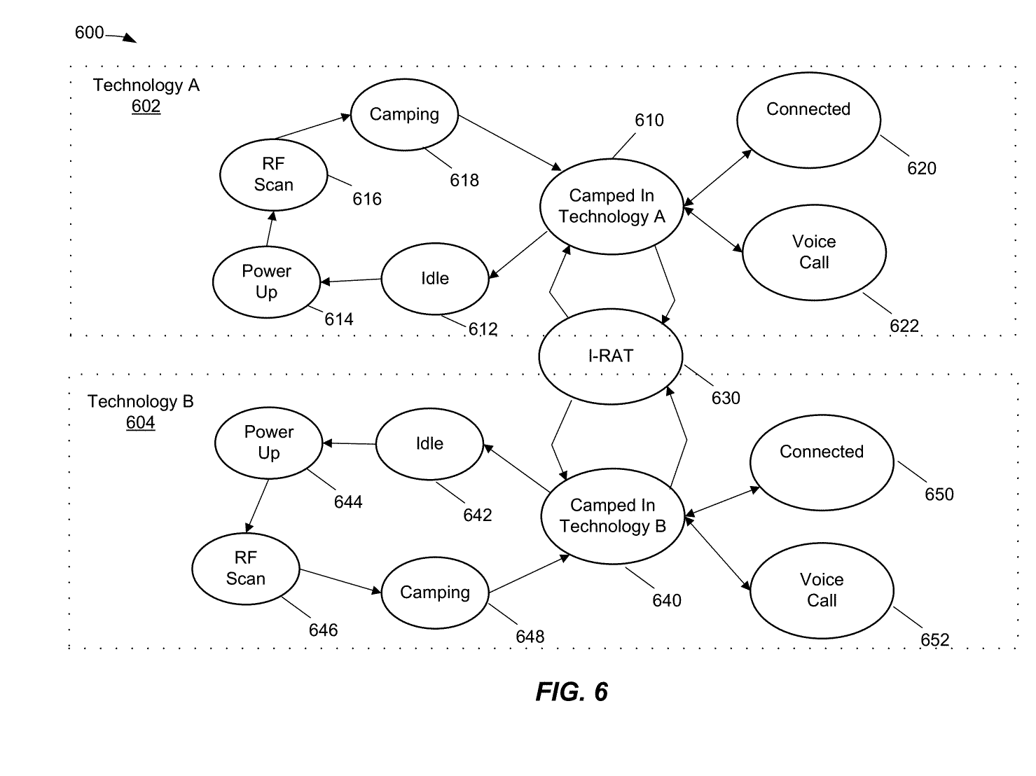

Referring back to FIG. 1, when a wireless device 110 (or PCD 320/420) is located in a cell 102 serviced by a base station 130 for example and has communication with the base station 130 of a particular wireless communication protocol, the wireless device 110 may be termed as “camped” within the wireless communication protocol of which the base station 130 is a part. For example, if base station 130 is part of a 3G network, the wireless device may be termed as camped in the 3G protocol/technology. Referring now to FIG. 6, this figure illustrates an exemplary state diagram showing an embodiment of exemplary states for the modem device 368/468 for a wireless Technology A 602 and a Wireless Technology B 604. Technology A 602 and Technology B 604 may each refer to any of the various wireless protocols, such as 2G, 3G, LTE, etc.

As shown in FIG. 6, the modem device 368/468 may be in a Camped In Technology A state 610. As part of becoming connected to wireless communication protocol of Technology A 602 and/or while camping in Technology A 602, the modem device 368/468 may enter into various other states. Among these states may be Idle 612 which may be a state where the modem device 368/468 is not in active communication with the wireless communication network 100 (FIG. 1), Power Up 644 which may be where the modem device 368/468 is required to verify connectivity with the wireless communications network 100 (FIG. 1), RF Scan 616 which may be where the modem tries to locate a base station available for communication (including base station 130 and base station 132 which may be part of a different wireless protocol/technology such as LTE), and camping 618, which may where the modem device 368/468 verifies connectivity to the wireless communications network 100 (FIG. 1). Additionally, the modem device 368/468 of the PCD 320/420 may be in active communication with the wireless communications network 100 (FIG. 1), such as in a Connected 620 state which may be for data transfer to and/or from the wireless device 110 (or PCD 320/420), or a Voice Call 622 state which may be voice calls involving the wireless device 110 (or PCD 320/420).

In some circumstances, for example where the wireless device 110 (or PCD 320/420) moves out of the cell 102 into another cell 102 where the wireless protocol of Technology A 602 does not have coverage, the wireless device 110 (or PCD 320/420) will need to handed off to a base station 132 from a different wireless protocol such as Technology B 604. Such transfers or hand-offs between wireless protocols (such as between 3G and LTE) is accomplished by Inter-Radio Access Technology (commonly known as I-RAT). Accordingly, the modem device 368/468 may also have an I-RAT 630 state to facilitate the transfer of the PCD 320/420 from one supported wireless protocol to another supported wireless protocol in accordance with I-RAT handover.

After the I-RAT handover to Technology B 604 is completed, the wireless device 110 (or PCD 320/420) may be considered camped in the new Technology B 604, which may include a Camped in Technology B 640 state for the modem device 368/468. Further, in some embodiments, the modem device 368/468 may have Idle 642, Power Up 644, RF Scan 646, Camping 648, Connected 650, and/or Voice Call 652 states corresponding to the Technology B 604.

Depending on the particular wireless technology/protocols associated with Technology A 602 and/or Technology B 604, there may be fewer or less states than the states shown in FIG. 6. For example, depending on the particular wireless protocol for Technology A 602, there may not be separate Connected 620 and Voice Call 622 states for the modem device 368/468. Similarly, although a “path” from one state to another is shown for some states in FIG. 6 for purposes of clarity, some implementations will have different paths and/or additional paths than those depicted in FIG. 6. For example, at least part of the path between certain states of the modem device 368/468 may be dictated by the requirements of Technology A with which the modem device 368/468 is in communication. For another example, although FIG. 6 depicts a path from the state of RF Scan 646 to the state of Camping 648 for Technology B 604, if the activities of the modem device 368/468 during an RF Scan 646 state do not locate any appropriate base stations for Technology B, the modem device 368/468 may move into an I-RAT 630, instead of a Camping 648 state as depicted in FIG. 6.

Moreover, each wireless technology may have differing requirements with which the modem device 368/468 has to comply for the various states. For example, the requirements for the modem device 368/468 for states of Idle 642, Power Up 644, and/or an RF Scan 644 where Technology B 604 is a 3G network may be different than the requirements for the same states where Technology B 604 is an LTE network.

Additionally, depending on the particular implementation of the modem device 368/468 and/or PCD 320/420 architecture, there may be more or fewer states than those illustrated in FIG. 6. Similarly, depending on the particular implementation, the states may be configured differently than shown in FIG. 6. For example in some implementations, the states of Idle 612 and Power Up 614 may consolidated into one state in the modem device 368/468 for some wireless technologies.

As noted above, each state may place different requirements on the modem device 368/468, as well as other components of the PCD 320/420. Some of these different states may place drastically different requirements on the modem device 368/468. A feature of an exemplary embodiment is the ability to dynamically configure the cache that the modem device 368/468 accesses to address, among other concerns, the differing requirements of the state of the modem device 368/468.

For example, in some implementations, a state of Idle 612 may require little cache. Accordingly, the determination may be made to enable only one of the caches for use by the modem device 368/468 and to disable pre-fetch in all caches when the modem device 368/468 is in the Idle 612 state in order to minimize the power consumption and/or free up cache resources for other functionality of the PCD 320/420. Alternatively, in a Connected 620 state when data is being transmitted to the PCD 320/420, it may be advantageous to make more cache available for the data being received, leading to the determination to enable all caches available, including external memory. However, such received data is typically “fresher” data, so pre-fetch may be disabled for all of the caches while the modem device 368/468 is in the Connected 620 state.

Providing another example, in some implementations, the modem device 368/468 in the Camping 618 state may require very little cache. Accordingly, the determination may be made to only enable a portion of one of the caches, such as a portion of the L2 cache, and to disable pre-fetching for only this portion of the L2 cache for the Camping 618 state in Technology A 602. Additionally, in some implementations, when the modem device 368/468 is in the I-RAT 630 state, pre-fetching in the cache may be desired in order to ensure connectivity and a smooth handover from Technology A 602 to Technology B 604. Accordingly, the determination may be made to enable all L1 cache and/or all L2 cache and to enable pre-fetching for the enabled cache(s) when the modem device 368/468 is in the I-RAT 630 state.

By dynamically configuring the cache according to the state of the modem device 368/468, the needs and requirements of each state (according to the PCD 320/420 architecture and/or requirements of the wireless protocol) may be specifically addressed. Dynamic configuration allows the modem device 368/468 to meet these needs, while at the same time, improving connectivity, reducing resource conflict (such as those caused by various caches being shared with other functionality of the PCD 320/420), reducing power consumption, reducing latency (such as from chip sets making less cache physically available), improving battery life, maximizing thermal performance, and/or improving QoS, depending on the desires and goals of the manufacturer or use of the PCD 320/420.

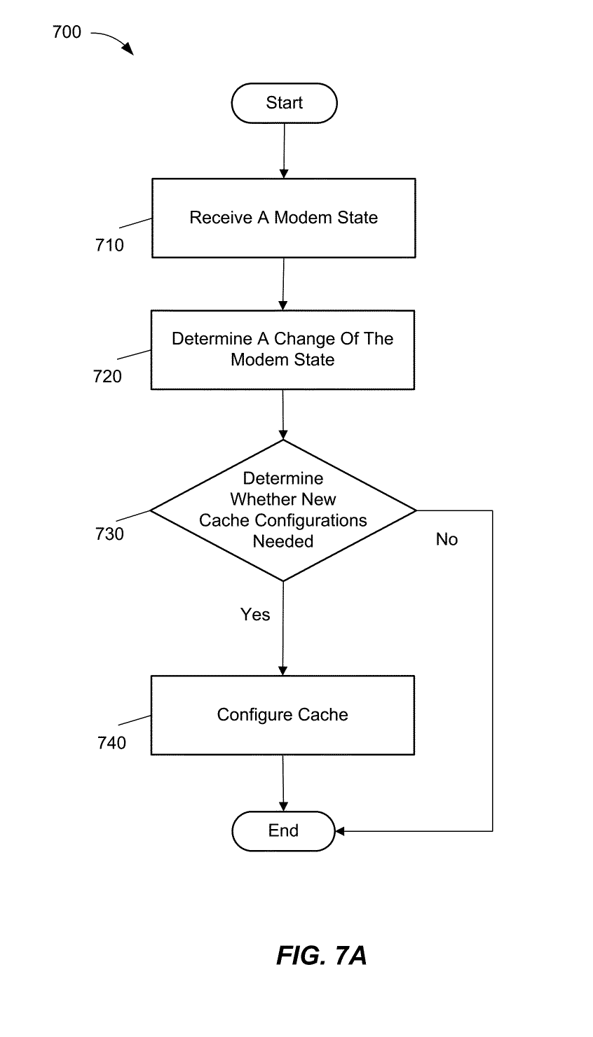

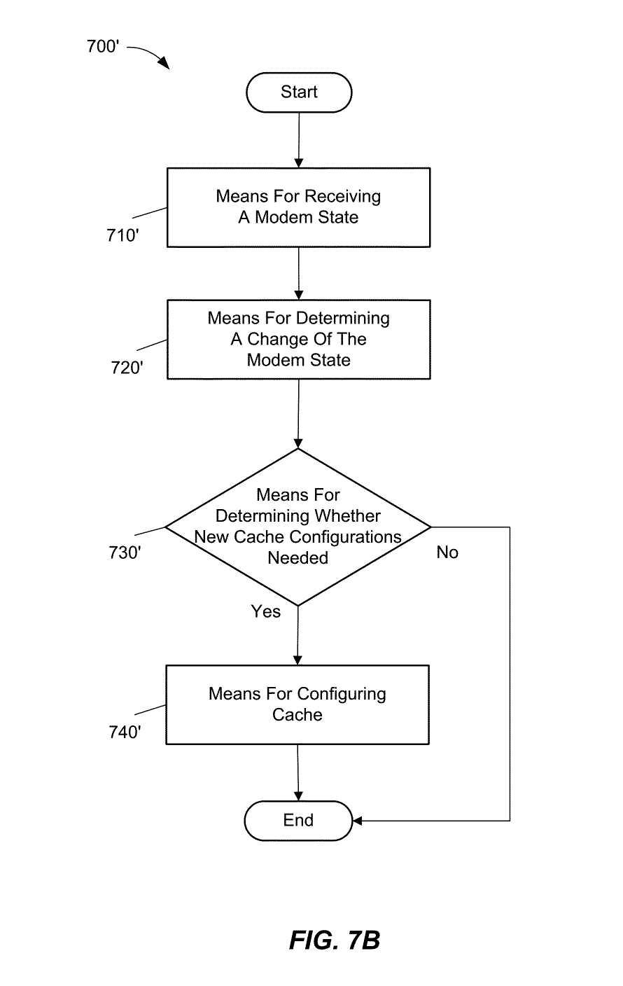

FIG. 7A is a flowchart describing an exemplary embodiment of a method for state-driven dynamic cache memory configuration in modems used in or with a PCD 320/420. The method 700 begins with block 710 where an indication of a modem state is received while the PCD 320/420 is in operation. As indicated above, the modem state may be a state dictated by a wireless protocol or may be a state defined by the hardware or software architecture of the modem device 368/468 and/or the PCD 320/420. In some implementations, the modem state may be received at regular intervals as an input, such for as example, to the modem processor 450/550 or another processor. In other implementations, instead of—or in addition to—receiving the modem state at a regular interval, the modem state may be received as a result or, or as a precursor to some event. For example, as discussed above in an RF Scan 616/646 state (FIG. 6) a scan of available base stations may be performed. The RF scan, or the results of said scan may be one example of an event that could cause a modem state to be received in some implementations. Any number or type of events could similarly result in receiving a modem state in block 710.

In block 720 a determination is made whether there is a change of the modem state. In some implementations, this determination could include a comparison of a record of the previously received modem state to the most recently received modem state from block 710. In other implementations, the determination could include using an algorithm, look-up table, or other methods to determine if the received modem state from block 710 represents a change in the modem state from a previous modem state.

Block 730 determines whether new cache configurations are needed. This determination may be made based on, or may be influence by, a variety of factors or parameters. Additionally, the determination of block 740 may be implemented by an algorithm, weighted formula, look-up table and/or or other methods. In various implementations, the determination in block 730 may be based in whole or in part on the modem state. The modem state may include any of the various modem states discussed above with respect to FIG. 6, or additional modem states that may be defined by a particular wireless protocol/technology, a particular PCD 320/420, or a particular modem device 368/468. Similarly, the determination at block 730 may also be based at least in part on the wireless network protocol in which the modem is operating.

Additionally, in various implementations the determination of block 730 may be based at least in part on PCD parameters. Such PCD parameters could include physical PCD parameters such as the architecture of the PCD 320/420, including the architecture of the modem device 368/468. For instance, the number of physical cache available to the modem device 368/468, the size of the cache available to the modem device 368/468, whether the available cache is shared with other processors of the PCD 320/420 performing other functions, whether the processor of the modem device performs other functions for the PCD 320/420, may be taken into account in the decision whether new cache configurations are needed in various implementations. The PCD parameters that the determination of block 730 may be based on also include operational PCD parameters. Examples of operational PCD parameters include the current conditions of the PCD 320/420 such as battery level, average power consumption, and/or thermal conditions and thresholds of the PCD 32/420.

Similarly, the determination at block 730 may also be based in various implementations on desired performance goals, such as improving connectivity, reducing resource conflict (such as those caused by various caches being shared with other functionality of the PCD 320/420), reducing power consumption, reducing latency (such as from chip sets that make less cache physically available), improving battery life, maximizing thermal performance, and/or improving QoS.

Any combination of the above factors or considerations may be taken into account as desired when making the determination of block 730. For example, in the event that the modem is changing to an I-RAT 630 state (FIG. 6), block 730 may determine that a change of configurations is needed. However, in the example for the particular PCD 320/420 implementation, the change from Technology A 602 to Technology B 604 requires a change from a first SIM card on the PCD 320/420 to a second SIM card on the PCD 320/420. This may require different cache configurations (such as making more numbers and amount of cache available) than would be needed for an I-RAT handover from Technology A 602 to Technology B (not shown) that did not require a change in SIM card. Continuing the example, block 703 may also take into account a low battery level, and parameters requiring the maximization of battery life. This may lead to additional configurations disabling pre-fetch for some or all of the selected cache as pre-fetch requires a relatively high level of power, that block 730 would not have determined at a higher batter level.

If no new configurations are determined to be needed in block 730, the method ends. If new configurations are needed, the cache is configured in block 740. As discussed above with respect to FIG. 5, the configurations of the cache in block 740 may include: setting or limiting which and/or how many of the L1 cache, L2 cache, L(n) cache, or DDR external memory will be used or accessed by the modem device 368/468; setting how fast one or more of the caches are operating and/or how fast one or more of the caches is being populated; limiting the information or types of information that may be placed into one or more of the caches or memories; and/or setting or limiting the availability of other features related to the caches, such as enabling or disabling pre-fetching for one or more of the caches. Such configurations may be performed by the modem processor 450/550, another processor, or a combination of the modem processor 450/550 with another processor.

In some implementations, block 740 implements the specific cache configurations that have already determined in block 730. In other implementations, the determination in block 730 only results in a flag or signal that new configurations are need, and block 740 calculates or otherwise decides the specific cache configurations to be applied and applying those configurations. Such determination of the specific configurations by block 740 may be implemented based on an algorithm, weighted formula, look-up table and/or or other methods. The specific configurations are based at least in part on the modem state, but may include any of the considerations discussed above for block 730. Indeed, in some embodiments of the method 700, blocks 730 and 740 may not be separate steps, but may be combined into one step of determining and applying any needed cache configurations.

Similarly, in various embodiments of the method 700 other blocks or steps shown in FIG. 7A may be combined or omitted. For example, in some embodiments, block 720 may be omitted such that whenever the modem state is received in block 710, block 730 automatically determines whether new cache configurations are needed. Such embodiments may allow change of the cache configurations based on other parameters (such as excessive power consumption, low battery, or exceeding temperature thresholds), even if the modem state had not changed, in addition to allowing change of the cache configurations when the modem state changes. Such variations of the method 700 are within the scope of the disclosure.

Additionally, certain steps in the processes or process flows described in this specification naturally precede others for the invention to function as described. However, the invention is not limited to the order of the steps described if such order or sequence does not alter the functionality of the invention. That is, it is recognized that some steps may performed before, after, or in parallel (substantially simultaneously) with other steps without departing from the scope of the invention. In some instances, certain steps may be omitted or not performed without departing from the invention. Further, words such as “thereafter”, “then”, “next”, “subsequently”, etc. are not intended to limit the order of the steps. These words are simply used to guide the reader through the description of the exemplary method.

The various operations and/or methods described above may be performed by various hardware and/or software component(s) and/or module(s) corresponding to means-plus-function blocks illustrated in the Figures. Generally, where there are methods illustrated in Figures having corresponding counterpart means-plus-function Figures, the operation blocks correspond to means-plus-function blocks with similar numbering. For example, blocks 710-740 illustrated in FIG. 7A correspond to means-plus-function blocks 710′-740′ illustrated in FIG. 7B.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed processor-enabled processes is explained in more detail in the above description and in conjunction with the drawings, which may illustrate various process flows.

In one or more exemplary aspects as indicated above, the functions described may be implemented in hardware, software, firmware, or any combination thereof. If implemented in software, the functions may be stored on or transmitted as one or more instructions or code on a computer-readable medium, such as a non-transitory processor-readable medium. Computer-readable media include both data storage media and communication media including any medium that facilitates transfer of a program from one location to another.

A storage media may be any available media that may be accessed by a computer or a processor. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of non-transitory computer-readable media.

Although selected aspects have been illustrated and described in detail, it will be understood that various substitutions and alterations may be made herein without departing from the present invention, as defined by the following claims.

What is claimed is:

1. A method for state-driven dynamic modem cache configuration in a portable computing device (PCD), the method comprising:
receiving during operation of the PCD an indication of a modem state;
determining a new cache configuration from the modem state; and
applying the new cache configuration to a modem cache memory.

2. The method of claim 1, further comprising:
determining a change in the modem state from the received indication and
wherein determining the new cache configuration further comprises determining the new cache configuration from the change in the modem state.

3. The method of claim 1, wherein determining the new cache configuration further comprises determining the new cache configuration from a look-up table.

4. The method of claim 1, wherein determining the new cache configuration further comprises determining the new cache configuration based in part on a PCD parameter.

5. The method of claim 4, wherein the PCD parameter comprises a physical PCD parameter.

6. The method of claim 4, wherein the PCD parameter comprises an operational PCD parameter.

7. The method of claim 4, wherein determining the new cache configuration further comprises determining the new cache configuration based in part on a requirement of a wireless communications protocol.

8. The method of claim 1, wherein the new cache configuration comprises setting a number of modem cache memories that may be accessed by a modem device.

9. The method of claim 8, wherein the new cache configuration comprises enabling pre-fetch for at least a portion of a modem cache memory.

10. The method of claim 8, wherein the new cache configuration comprises setting a rate at which a modem cache memory operates.

11. A portable computing device (PCD), comprising:
a modem device, the modem device comprising a processing resource configured to:
receive during operation of the PCD an indication of a modem state;
determine a new cache configuration from the modem state; and
apply the new cache configuration to a modem cache memory.

12. The portable computing device of claim 11, wherein the processing resource is further configured to:
determine a change in the modem state from the received indication and
determine the new cache configuration from the change in the modem state.

13. The portable computing device of claim 11, wherein 1, wherein the processor is further configured to determine the new cache configuration using a look-up table.

14. The portable computing device of claim 11, wherein the processor is further configured to determine the new cache configuration based in part on a PCD parameter.

15. The portable computing device of claim 14, the processor is further configured to determine the new cache configuration based in part on a requirement of a wireless communications protocol.

16. The portable computing device of claim 11, wherein the new cache configuration comprises setting a number of modem cache memories that may be accessed by the modem device.

17. The portable computing device of claim 16, wherein the new cache configuration comprises enabling pre-fetch for at least a portion of a modem cache memory.

18. A non-transitory processor-readable medium having stored thereon processor instructions that direct the processor to perform functions for state-driven dynamic modem cache configuration in a portable computing device (PCD), comprising:
receiving during operation of the PCD an indication of a modem state;
determining a change in the modem state from the received indication;
determining a new cache configuration from the change in the modem state; and
applying the new cache configuration to a modem cache memory.

19. The non-transitory processor-readable medium of claim 18, wherein determining the new cache configuration further comprises determining the new cache configuration based in part on a PCD parameter.

20. The non-transitory processor-readable medium of claim 19, wherein determining the new cache configuration further comprises determining the new cache configuration based in part on a requirement of a wireless communications protocol.
